(19) United States
(12) Patent Application Publication
(10) Pub. No.: US 2004/0205543 A1
(43) Pub. Date: Oct. 14, 2004

(54) Apparatus and method of bookmarking a section of a web page

(75) Inventors: Faisal M. Awada, Round Rock, TX (US); Joe Nathan Brown, Austin, TX (US); Herman Rodriguez, Austin, TX (US); Newton James Smith JR., Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 10/002,438

(22) Filed: Nov. 1, 2001

(51) Int. Cl. G06F 15/00

(52) U.S. Cl. 715/512; 715/501.1

(57) ABSTRACT

A method and apparatus for bookmarking a section of a Web page are provided. When a Web page is being bookmarked, if the user so chooses, the user may store in conjunction with the URL of the page the size of the window within which the page is displayed, the location of both the horizontal and vertical scroll boxes in the window and the font attributes used to display the page. This allows the section of the page that was displayed when the page was bookmarked to be displayed whenever the bookmarked Web page is re-accessed.

### BACKGROUND OF THE INVENTION

1. Technical Field

The present invention is directed to a method and apparatus for managing bookmark folders. More specifically, the present invention is directed to an apparatus and method of bookmarking a section of a Web page.

2. Description of Related Art

As is well known by now, the World Wide Web (WWW) or Internet is a system of servers that support documents formatted in Hyper Text Markup Language (HTML). HTML supports links to documents as well as to graphics, audio and video files. Links are references to documents from within other documents. Links allow a user to easily jump from one document or Web page to another with just a click of a mouse. Thus, a link can be a very useful Internet navigational tool. Note that Web page and document will henceforth be used interchangeably.

Another useful Internet navigational tool is a bookmark. A bookmark is a feature that is available in most Web browsers that allows a user to store Web addresses or URLs (abbreviation for Uniform Resource locators) of Web pages, that are to be later re-visited, into a folder (i.e., a bookmark folder). (A Web browser is a software application that is used to locate Web sites and display Web pages.) U.S. Pat. No. 6,037,944 issued to Himmel et al. and entitled NAMED BOOKMARK SETS as well as U.S. Pat. No. 6,208,995 B1 issued to the same inventors and entitled WEB BROWSER DOWNLOAD OF BOOKMARK SET describe how a bookmark is downloaded into a bookmark folder. The description in both patents is herein incorporated.

Thus, when a user accesses a Web page that may later be re-visited, the user may bookmark the page. But, when the Web page is re-visited, the page is always displayed from its beginning. If the user wanted to return to a passage that is in the middle or near the end of the page, the user has to scroll down the page looking for the passage. This can be a non-trivial endeavor, especially, if the document being revisited is a large one.

What is needed, therefore, is a method and apparatus for bookmarking a precise area of a page when bookmarking the page.

### SUMMARY OF THE INVENTION

The present invention provides a method and apparatus for bookmarking a section of a Web page. When a Web page is being bookmarked, if the user so chooses, the user may store in conjunction with the URL of the page the size of the window within which the page is displayed, the location of both the horizontal and vertical scroll boxes in the window and the font attributes used to display the page. This allows the section of the page that was displayed when the page was bookmarked to be displayed whenever the bookmarked Web page is re-accessed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a representative graphical user interface (GUI) of a Web browser.

FIG. 5 is a typical bookmark folder.

FIG. 6 depicts a GUI for bookmarking a Web page.

FIG. 7 depicts a GUI for bookmarking a Web page used by the present invention.

FIG. 8 illustrates a flow chart of a process used by the present invention to bookmark a Web page.

FIG. 9 illustrates a flow chart of a process used by the present invention to retrieve a bookmarked Web page.

### DETAILED DESCRIPTION OF THE PREFERRED EMBODIMENT

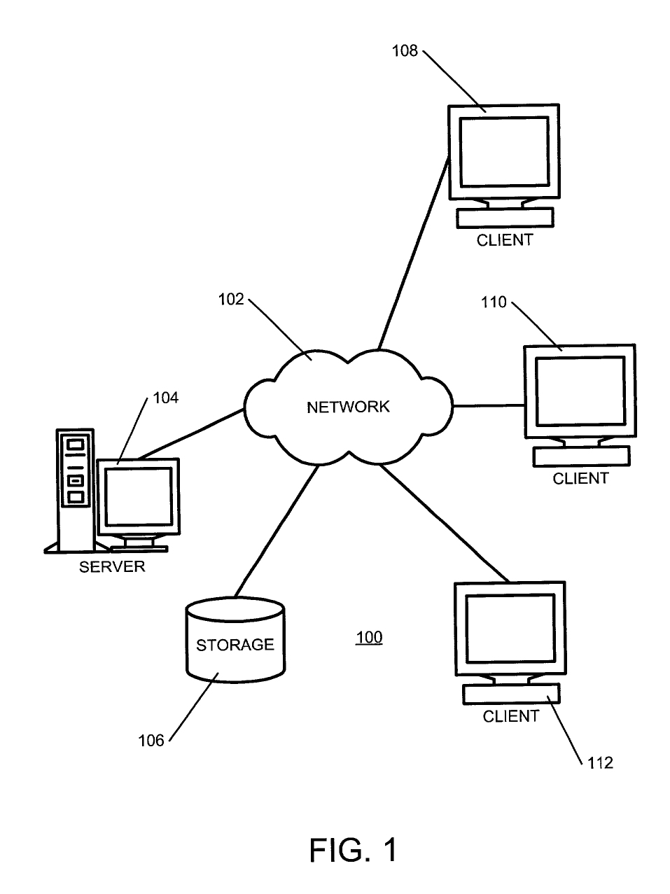

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

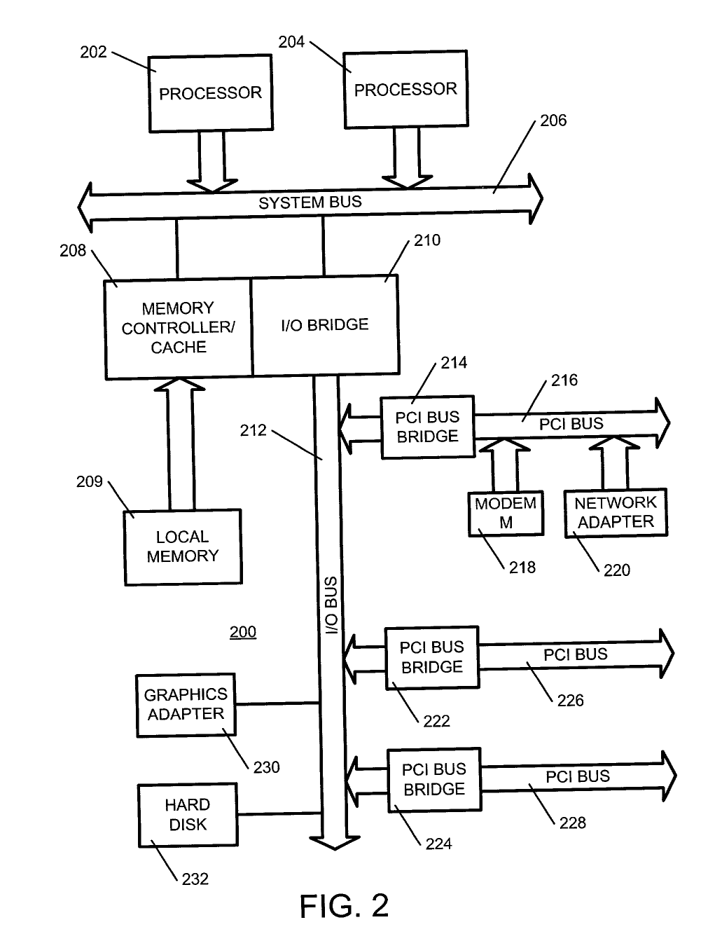

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

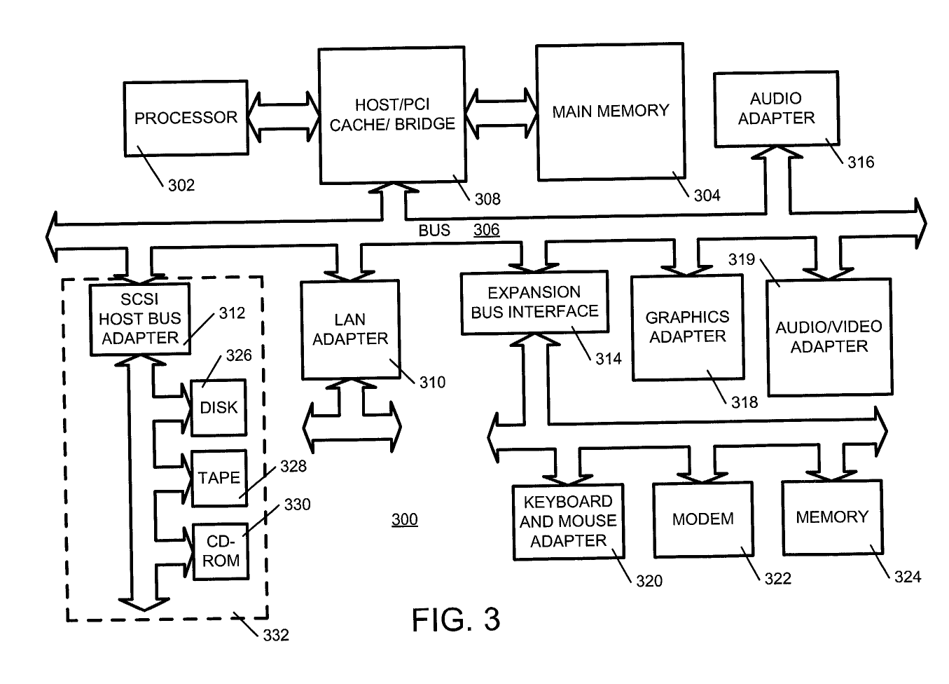

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of bookmarking a specific section of a Web page. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

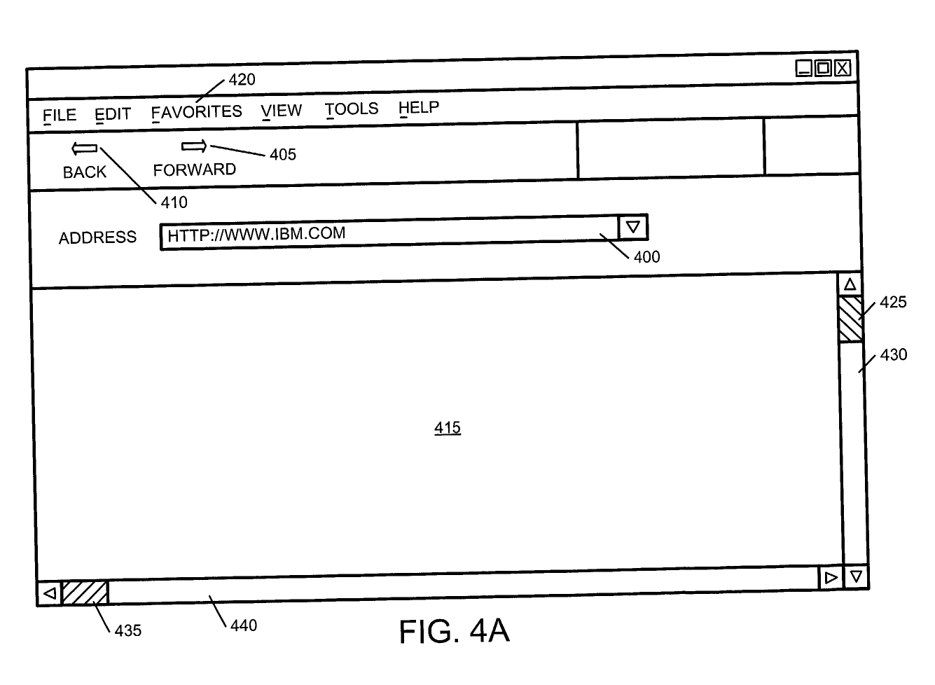

FIG. 4 (i.e., FIGS. 4A and 4B) is a representative graphical user interface (GUI) of a Web browser. Not all items in the GUI are shown and only the items of importance to the invention are given a reference numeral. When a Web browser is activated and a Web page is accessed, the content of the page is displayed in area 415, the address or URL of the page is displayed in address box 400. Back arrow 410 and forward arrow 405 are not live (i.e., a user cannot assert them to get to a Web page). Scroll box 425 is located at the very top of vertical scroll bar 430 and scroll box 435 is to the far left of horizontal scroll bar 440 as shown in FIG. 4A. Note that the scroll box 425 will not be displayed if the document can fit (lengthwise) within the window within which the GUI is displayed. Likewise, scroll box 435 will not be displayed if the document can fit (widthwise) within the window.

To access a part of the Web page that is not currently displayed, the user has to scroll through the document. There is a plurality of ways that can be used to scroll through a document. For instance, a user may use the up or down arrow of the keyboard, drag the scroll box up or down, click on the up or the down arrow in the scroll bar or click above or below the scroll box to scroll up or down through the Web page. In any case, when the user scrolls through to approximately the midpoint mark of the Web page, the scroll box will move down to about the middle of the scroll bar as shown in FIG. 4B. FIG. 4B also illustrates the scroll box 435 away from the far left side of the GUI signifying that the document has been scrolled to the right.

As stated above, presently when a bookmarked page is re-visited, the page is displayed at its beginning. If the user wants to consult a particular passage located, for example, midway through the page, the user has to scroll down until the passage in question is found. The present invention allows the screen that was displayed when the user bookmarked the page to be displayed upon accessing the bookmarked Web page.

To bookmark a page, the bookmark folder has to be opened. In Netscape Navigator, a user has to click once on a “Bookmark” icon and in Internet Explorer the user has to click once on a “Favorites” icon to open the bookmark folder. In this particular example, Internet Explorer is used. However, it should be understood that any Web browser having a bookmark feature may be used with the invention.

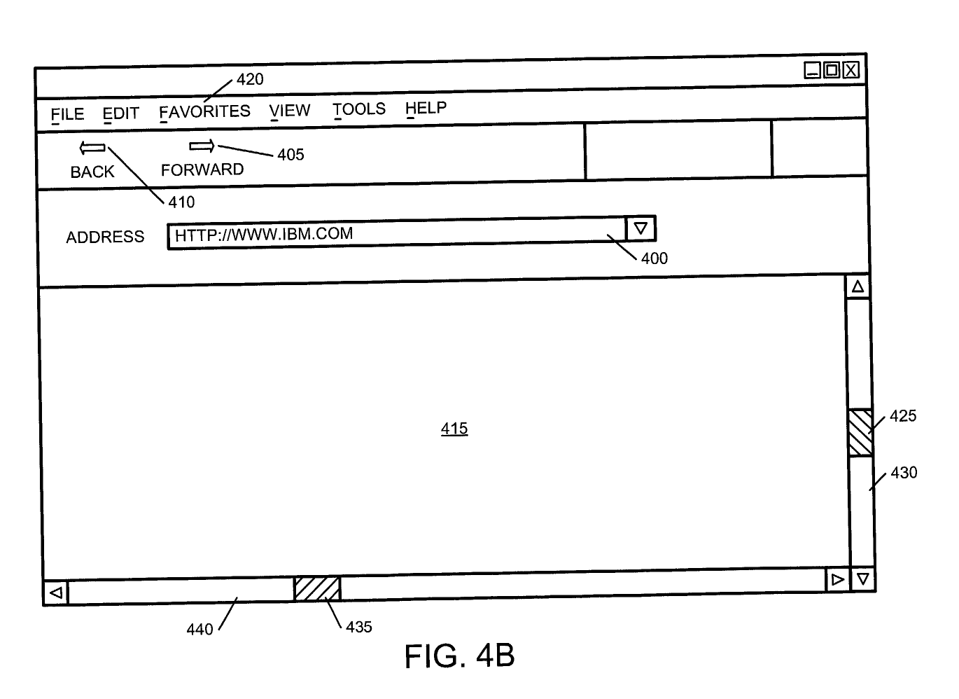

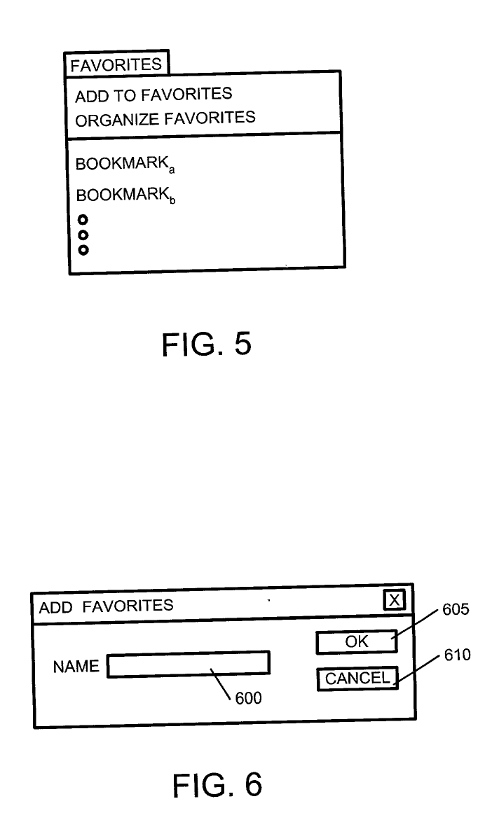

Returning to either FIG. 4A or 4B, when the menu in Favorites item 420 is pulled down, the GUI in FIG. 5 is displayed. When a user asserts “add to Favorites”, FIG. 6 is displayed. In name box 600 is displayed a default name associated with the URL. If the user so wants, the user may replace the default name by another name of the user's liking. When done, ok button 605 can be asserted to bookmark the page, or cancel button 610 can be asserted to close the FIG. 6 without bookmarking the page.

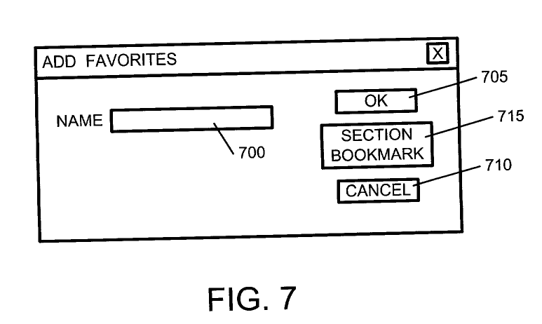

FIG. 7 is a depiction of FIG. 6 with an added button. The added button is “section bookmark button” 715. Name box 700, ok button 705 and cancel button 710 have the same purpose as name box 600, ok button 605 and cancel button 610 in FIG. 6. When the user asserts section bookmark button 715, the size of the window (i.e., the X-Y coordinates of the four corners of the window relative to the top left corner of the window), the location of the scroll boxes 425 and 435 as well as the font attributes will all be stored with the URL of the page. When the user accesses the bookmark folder (i.e., the “Favorites” pull down menu) anytime thereafter, the Web pages bookmarked by section may be displayed in a different color or different font in order to be distinguishable from the regular bookmarks. Note that, although a different color or a different font is disclosed, they are not all inclusive, any other manner that may be used to make the section bookmarks distinguishable from the regular bookmarks is perfectly within the scope of the present invention.

When a section bookmark is asserted, the Web page represented by the URL will be accessed. As the page is being downloaded, the size of the window will be adjusted to the size in use when the page was bookmarked using the stored X-Y coordinates. The font attributes that were stored with the bookmarked page will also be used to display the Web page (type and size of the font that was in use when the page was bookmarked). Then, the page will be scrolled to the section that was displayed when the page was bookmarked by placing the scroll boxes 425 and 435 at the stored positions (again X-Y coordinates may be used). Consequently, the same section of the Web page that was displayed when the page was bookmarked will be re-displayed when the bookmarked page is accessed.

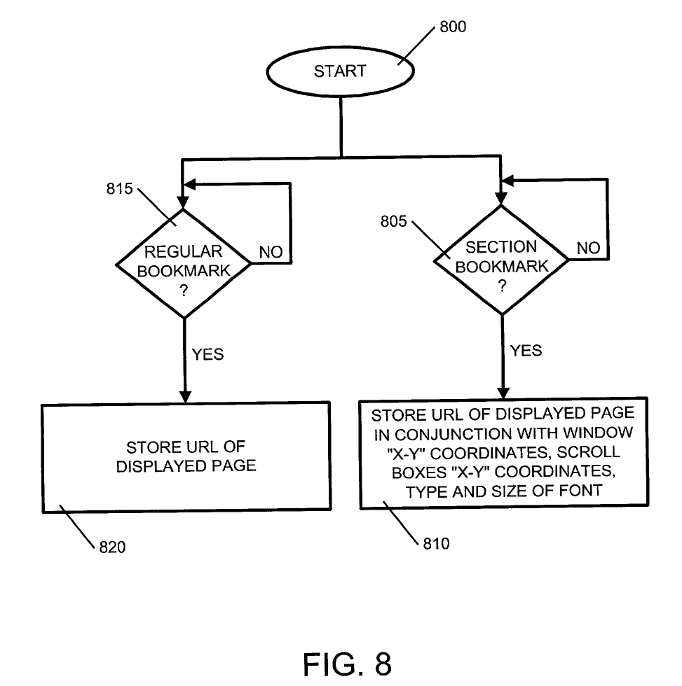

FIG. 8 illustrates a flow chart of a process used by the present invention to bookmark a Web page. The process starts as soon as the bookmark folder is accessed (step 800). Two tests then are continuously being made. The first one is to determine whether the user wants to bookmark a Web page the usual way. If so, then the URL of the displayed Web page is stored with the title of the page if there is one (steps 815 and 820). The second test is to determine whether the user wants to bookmark a section of the Web page. If so, the size of the window, the position of the scroll boxes and the font attributes of the text will all be store in conjunction with the URL of the page and the page title if there is one (steps 805 and 810).

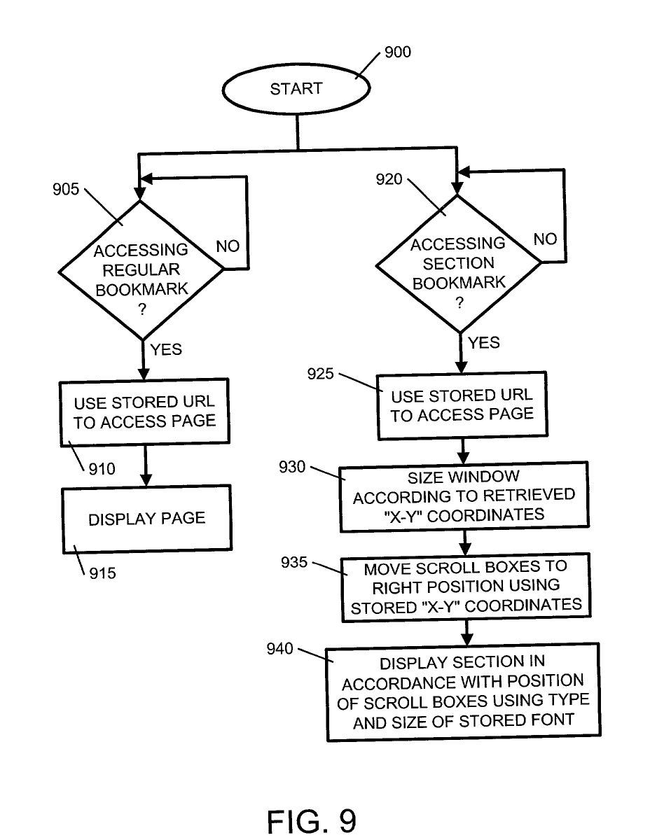

FIG. 9 illustrates a flow chart of a process used by the present invention to retrieve a bookmarked Web page. Again, the process starts as soon as the bookmark folder is accessed (step 900). Then two tests are continuously being made. The first one is to determine whether a bookmarked Web page is to be accessed. If so, the stored URL is used to download and display the Web page (steps 905, 910 and 915). The second test is to determine whether a section of a bookmarked page is to be accessed. If so, the stored URL is used to download the Web. The stored X-Y coordinates of the window are used to restore the window to the size it was when the page was bookmarked. The stored font attributes are used to display the page. Then, using the X-Y coordinates of the scroll boxes, the Web page is scrolled to the section that was displayed when the page was bookmarked (steps 920, 925, 930, 835 and 940).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of bookmarking a section of a Web page comprising the steps of:
storing a network address of the page; and
storing the section of the page such that when the network address is used to access and display the page, the section of the page is displayed.

2. The method of claim 1 wherein the section of the page being stored is the section of the page displayed when the network address is stored.

3. The method of claim 2 wherein the step of storing the section of the page includes storing current size of a window within which the page is displayed.

4. The method of claim 3 wherein the step of storing the section of the page includes storing positions of scroll boxes in scroll bars in the window.

5. The method of claim 4 wherein the step of storing the section of the page further includes storing font attributes of the displayed page.

6. The method of claim 5 wherein the step of storing the section of the page includes storing X-Y coordinates of the window and the scroll boxes.

7. A computer program product on a computer readable medium for bookmarking a section of a Web page comprising:
code means for storing a network address of the page; and
code means for storing the section of the page such that when the network address is used to access and display the page, the section of the page is displayed.

8. The computer program product of claim 7 wherein the section of the page stored is the section of the page displayed when the network address is stored.

9. The computer program product of claim 8 wherein the code means for storing the section of the page includes code means for storing current size of a window within which the page is displayed.

10. The computer program product of claim 9 wherein the code means for storing the section of the page includes code means for storing positions of scroll boxes in scroll bars in the window.

11. The computer program product of claim 10 wherein the code means for storing the section of the page further includes code means for storing font attributes of the displayed page.

12. The computer program product of claim 11 wherein the code means for storing the section of the page includes code means for storing X-Y coordinates of the window and the scroll boxes.

13. An apparatus for bookmarking a section of a Web page comprising:
means for storing a network address of the page; and
means for storing the section of the page such that when the network address is used to access and display the page, the section of the page is displayed.

14. The apparatus of claim 13 wherein the section of the page being stored is the section of the page displayed when the network address is stored.

15. The apparatus of claim 14 wherein the means for storing the section of the page includes means for storing current size of a window within which the page is displayed.

16. The apparatus of claim 15 wherein the means for storing the section of the page includes means for storing positions of scroll boxes in scroll bars in the window.

17. The apparatus of claim 16 wherein the means for storing the section of the page further includes means for storing font attributes of the displayed page.

18. The apparatus of claim 17 wherein the means for storing the section of the page includes means for storing X-Y coordinates of the window and the scroll boxes.

19. A computer system for bookmarking a section of a Web page comprising:
at least a memory device for storing data;
at least a processor for processing said data to store a network address of the page and to store the section of the page such that when the network address is used to access and display the page, the section of the page is displayed.

20. The computer system of claim 19 wherein the section of the page being stored is the section of the page displayed when the network address is stored.

21. The computer system of claim 20 wherein the section of the page is stored by storing a current size of a window within which the page is displayed.

22. The computer system of claim 21 wherein the section of the page is stored by further storing positions of scroll boxes in scroll bars in the window.

23. The computer system of claim 22 wherein the section of the page is stored by further storing font attributes of the displayed page.

24. The computer system of claim 23 wherein the section of the page is stored by further storing X-Y coordinates of the window and the scroll boxes.
